(19) United States
(12) Patent Application Publication
(10) Pub. No.: US 2019/0148057 A1
(43) Pub. Date: May 16, 2019

(54) INDUCTOR

(71) Applicant: FDK CORPORATION, Tokyo (JP)

(72) Inventors: Takashi Takiguchi, Tokyo (JP); Takahiro Shimizu, Tokyo (JP)

(73) Assignee: FDK CORPORATION, Tokyo (JP)

(21) Appl. No.: 16/224,802

(22) Filed: Dec. 19, 2018

Related U.S. Application Data
(63) Continuation of application No. PCT/JP2017/022071, filed on Jun. 15, 2017.

(30) Foreign Application Priority Data
Jun. 22, 2016 (JP) 2016-123512

(51) Int. Cl. H01F 27/32; H01F 27/26; H01F 27/28

(52) U.S. Cl. CPC H01F 27/324; H01F 27/2847; H01F 27/263

(57) ABSTRACT

An inductor includes: a coil; a first separate cover made of insulating resin, the first separate cover including a wall inserted into the coil from one end of the coil along one side of an inner peripheral surface of the coil, and a flange continued from the wall and abutting on the one end; a second separate cover made of insulating resin, the second separate cover including a wall inserted into the coil from another end of the coil along another side of the inner peripheral surface of the coil, and a flange continued from the wall and abutting on the other end; and a conductive core to be stored between the wall of the first separate cover and the wall of the second separate cover in the coil.

### CROSS-REFERENCE TO RELATED APPLICATIONS

This patent application is a continuation application of International Patent Application No. PCT/JP2017/022071, filed Jun. 15, 2017, which claims the benefit of priority to Japanese Patent Application No. 2016-123512, filed Jun. 22, 2016 the entire disclosures of which are hereby incorporated by reference herein.

### BACKGROUND

### Technical Field

The present disclosure relates to an inductor suitable for use in a high-power-supply device and the like of various types of electronic and electric equipment.

### Background Art

In an inductor used in a high-power-supply device and the like, an electric wire having a large cross-sectional area, such as a rectangular copper wire, has been widely used for a coil in order to reduce electric resistance and heat generation. In a case where a core for forming a magnetic path with currents flowing through the coil has conductivity, an insulation material is needed between the coil and the core.

Accordingly, the coil is usually provided with insulation coating. However, when high insulation performance, for example, a withstand voltage of 500 V or above, is required, it may be impossible to ensure the abovementioned insulation performance since, for example, the abovementioned insulation coating alone may fail to withstand the required high voltage or may cause local delamination.

For this reason, in general, insulating parts made of insulating resin are additionally interposed between the abovementioned core and coil, to ensure the insulation required between the abovementioned core and coil.

FIGS. 9 and 10 illustrate an inductor 24 of this type.

The inductor 24 includes a resin case 20 and a resin cap 21 as the abovementioned insulating parts. The inductor 24 is formed by: putting the resin cap 21 on a coil 23 in which a rectangular copper wire is wound edgewise; storing the coil 23 into the resin case 20, and then making a pair of E-shaped cores 22 face each other with their middle legs 22a being inserted into the center portions of the resin case 20 and the resin cap 21 and their outer legs 22b being arranged on an outer surface of the resin case 20.

Also, an inductor disclosed in Japanese Patent Application Publication No. 2010-219473 has been known.

In the inductor 24 that uses an electric wire having a large cross-sectional area, such as the abovementioned rectangular copper wire, for the coil 23, two types of resin parts such, as the resin case 20 and the resin cap 21, are necessary for ensuring the insulation between the coil 23 and the core 22. Thus, two types of molds for manufacturing these resin parts are necessary, resulting in increase in manufacturing cost.

In addition, since the coil 23 that is formed by pressing electric wire has no insulation coating, the insulation between portions adjacent to each other of the electric wire has to be ensured with a resin mold and/or the like formed by insert molding in order to prevent contact between the portions adjacent to each other of the electric wire. This leads to further increase in cost.

### SUMMARY

The present disclosure provides an inductor that can ensure the insulation between a coil and a core with an inexpensive and simple structure and that is thus suitable for use in a high-power-supply device and/or the like.

In one aspect of this disclosure, an inductor includes: a coil; a first separate cover made of insulating resin, the first separate cover including a wall inserted into the coil from one end of the coil along one side of an inner peripheral surface of the coil, and a flange continued from the wall and abutting on the one end; a second separate cover made of insulating resin, the second separate cover including a wall inserted into the coil from another end of the coil along another side of the inner peripheral surface of the coil, and a flange continued from the wall and abutting on the other end; and a conductive core to be stored between the wall of the first separate cover and the wall of the second separate cover in the coil.

It is possible to ensure the insulation between a coil and a core with an inexpensive and simple structure.

### BRIEF DESCRIPTION OF THE DRAWINGS

FIG. 1 is a perspective view illustrating an inductor according to First Embodiment.

FIG. 2 is an exploded perspective view of the inductor illustrated in FIG. 1.

FIG. 3A is a diagram illustrating an aspect in which first and second separate covers are attached to a coil.

FIG. 3B is a diagram illustrating an aspect in which the first and second separate covers are attached to the coil.

FIG. 3C is a diagram illustrating an aspect in which the first and second separate covers are attached to the coil.

FIG. 3D is a diagram illustrating an aspect in which the first and second separate covers are attached to the coil.

FIG. 3E is a diagram illustrating an aspect in which the first and second separate covers are attached to the coil.

FIG. 3F is a diagram illustrating an aspect in which the first and second separate covers are attached to the coil.

FIG. 4 is a perspective view illustrating an inductor according to Second Embodiment.

FIG. 5 is an exploded perspective view of the inductor illustrated in FIG. 4.

FIG. 6A is a diagram illustrating an aspect in which first and second separate covers are attached to a coil.

FIG. 6B is a diagram illustrating an aspect in which the first and second separate covers are attached to the coil.

FIG. 6C is a diagram illustrating an aspect in which the first and second separate covers are attached to the coil.

FIG. 6D is a diagram illustrating an aspect in which the first and second separate covers are attached to the coil.

FIG. 6E is a diagram illustrating an aspect in which the first and second separate covers are attached to the coil.

FIG. 7A is a schematic diagram for describing an inductor according to Third Embodiment.

FIG. 7B is a schematic diagram for describing the inductor according to Third Embodiment.

FIG. 7C is a schematic diagram for describing the inductor according to Third Embodiment.

FIG. 7D is a schematic diagram for describing the inductor according to Third Embodiment.

FIG. 7E is a schematic diagram for describing the inductor according to Third Embodiment.

FIG. 7F is a schematic diagram for describing the inductor according to Third Embodiment.

FIG. 8A is a schematic diagram for describing an inductor according to Fourth Embodiment.

FIG. 8B is a schematic diagram for describing the inductor according to Fourth Embodiment.

FIG. 8C is a schematic diagram for describing the inductor according to Fourth Embodiment.

FIG. 8D is a schematic diagram for describing the inductor according to Fourth Embodiment.

FIG. 8E is a schematic diagram for describing the inductor according to Fourth Embodiment.

FIG. 9 is a perspective view illustrating an inductor different from the inductors of the present embodiments.

FIG. 10 is an exploded perspective view of the inductor illustrated in FIG. 9.

### DETAILED DESCRIPTION

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Referring now to the drawings, wherein like reference numerals designate identical or corresponding parts throughout the several views thereof, an inductor according to embodiments of the present disclosure are described. As used herein, the singular forms “a” , “an”, and “the” are intended to include the plural forms as well, unless the context clearly indicates otherwise.

### First Embodiment

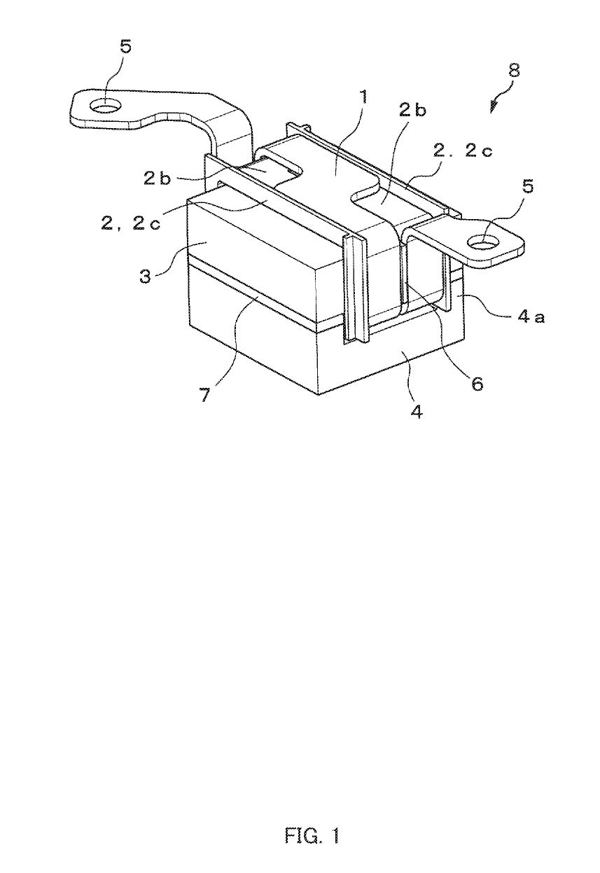

FIGS. 1, 2, and 3A to 3F illustrate an inductor 8 according to First Embodiment of the present disclosure. As illustrated in FIGS. 1 and 2, this inductor 8 schematically includes a coil 1 in which a rectangular copper wire is wound, a pair of separate covers (first and second separate covers) 2 made of insulating resin and having the same shape, which cover an inner peripheral surface 1a and two end surfaces 1b in the axial direction of the coil 1, and an I-shaped core 3 and a U-shaped core 4 having conductivity that form a closed magnetic circuit in a hollow square-shaped by surrounding the center portion and the outer peripheries of the separate covers 2 and the coil 1.

In this case, the coil 1 is formed to have an appearance in a substantially rectangular tube shape, in which the pressed rectangular copper wire is bent in out-of-plane directions and its winding portions are adjacent to each other in the axial direction, and its terminal portions are respectively provided with screw holes 5 for screw fastening that are drilled during the abovementioned pressing. In this way, the coil 1 is formed by being wound with its belt-shaped metal plate being exposed.

The separate covers 2 each include a first wall 2a covering the entirety of one surface of the inner peripheral surfaces 1a on the short sides of the rectangular tube shaped coil 1, second walls 2b each diagonally covering about a half of a corresponding surface of the inner peripheral surfaces 1a on the long side adjacent to the abovementioned inner peripheral surface 1a on the short sides, and a flange 2c integrally formed on base ends of the first and second walls 2a and 2b and covering one of the end surfaces (ends) 1b of the coil 1.

The first separate cover 2 and the second separate cover 2 are respectively attached to the coil 1 from one end and the other end of the coil 1 such that the first and second separate covers 2 face each other.

To be more specific, the first wall 2a and the second wall 2b of the first separate cover 2 are inserted into the coil 1 along the one side of the inner peripheral surface 1a of the coil 1 from the one end of the coil 1, respectively. The flange 2c of the first separate cover 2 then abuts on the one end surface 1b of the coil 1.

The first wall 2a and the second wall 2b of the second separate cover 2 are inserted into the coil 1 along the other side of the inner peripheral surface 1a of the coil 1 from the other end of the coil 1. The flange 2c of the second separate cover 2 then abuts on the other end surface 1b of the coil 1.

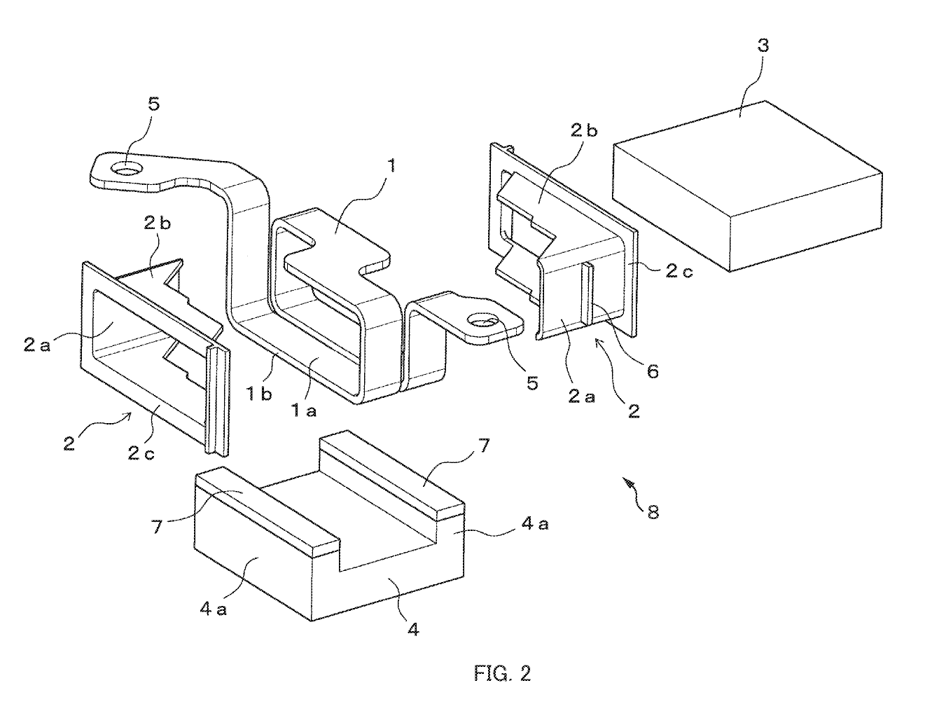

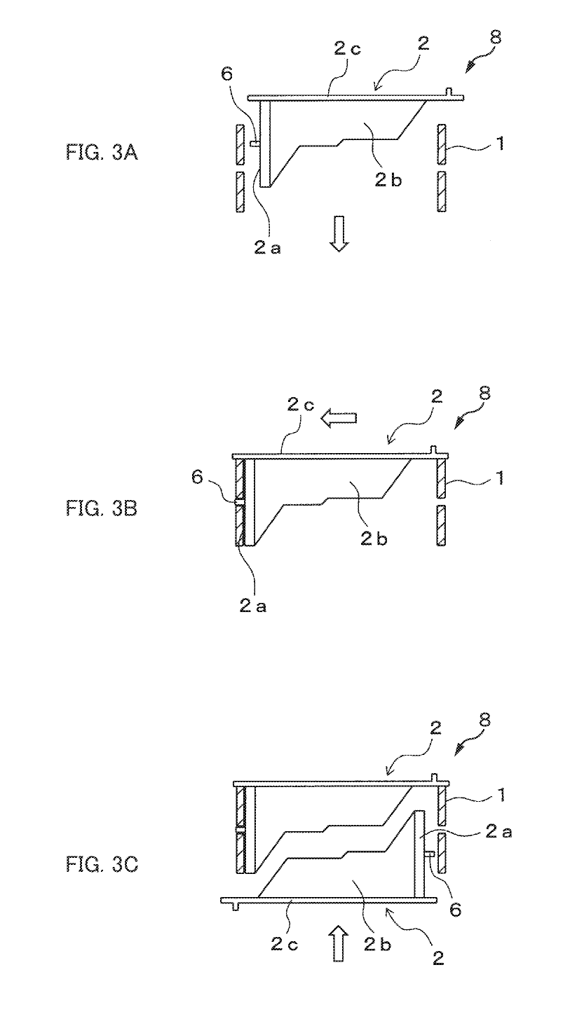

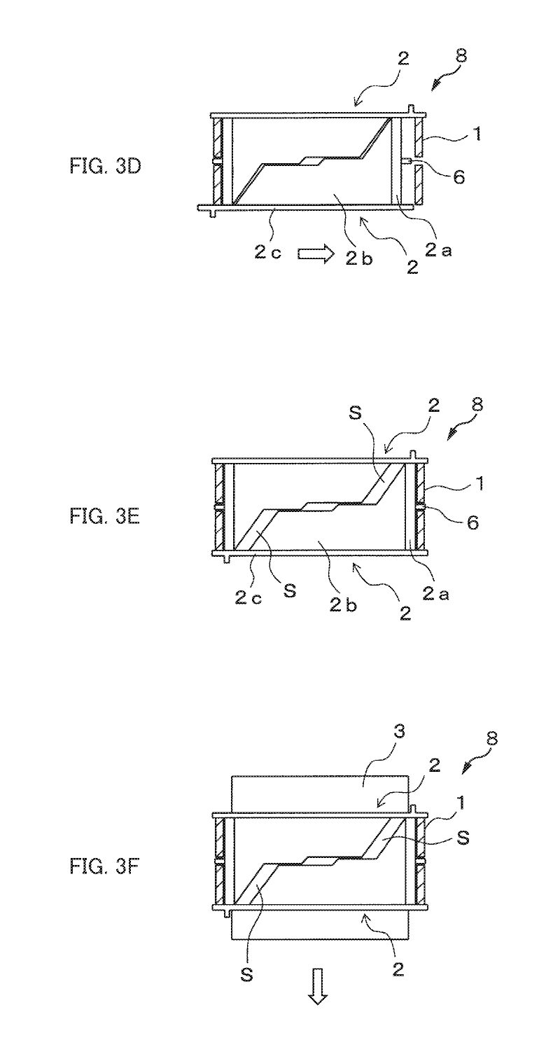

At this time, the first separate cover 2 and the second separate cover 2 are formed with such dimensions that a clearance S is formed between the second walls 2b of the first and second separate covers 2 in the circumferential direction of the coil 1 (see FIGS. 3E and 3F).

A projection 6, which is to be inserted between the winding portions adjacent to each other in the axial direction of the coil 1, is integrally formed on a center portion of an outer surface of the first wall 2a of each separate cover 2. Each of the first walls 2a of the first separate cover 2 and the second separate cover 2 is provided with the projection 6, which is formed to be inserted between the portions adjacent to each other of the metal plate of the coil 1 to separate these portions of the metal plate from each other.

A gap sheet 7 is interposed between two ends of the I-shaped core 3 and end surfaces of outer legs 4a of the U-shaped core 4, which are coupling portions for forming the hollow square-shaped core.

In order to assemble the inductor 8 having the abovementioned configuration, firstly one of the separate covers 2 is inserted from the one end surface 1b side of the coil 1 as illustrated in FIG. 3A, and thereafter the one separate cover 2 is moved toward the inner peripheral surface 1a on one short side of the coil 1, so that the first wall 2a abuts on the abovementioned inner peripheral surface 1a while inserting the projection 6 between the adjacent winding portions of the coil 1 and covering the one end surface 1b of the coil 1 with the flange 2c, as illustrated in FIG. 3B.

Subsequently, the other one of the separate covers 2 is inserted from the other end surface 1b side of the coil 1 and is similarly moved to the inner peripheral surface 1a side on the other short side of the coil 1 as illustrated in FIG. 3C, and the first wall 2a abuts on the abovementioned inner peripheral surface 1a while inserting the projection 6 between the adjacent winding portions of the coil 1 and covering the other end surface 1b of the coil 1 with the second walls 2b, as illustrated in FIG. 3D.

As a result, the clearance S is formed between the second walls 2b of the two separate covers 2 in the circumferential direction of the coil 1. Subsequently, the I-shaped core 3 is inserted into the separate covers 2, and then they are arranged between the outer legs 4a of the U-shaped core 4. Accordingly, the abovementioned assembly is completed.

According to the inductor 8 having the abovementioned configuration, the clearance S is formed between the second walls 2b of the pair of the separate covers 2 in the circumferential direction of the coil 1. Thus, the separate covers 2 can be attached into the coil 1 by sequentially inserting them into the coil 1 and moving them toward the respective inner peripheral surfaces 1a on the short sides and also the abovementioned separate covers 2 can be prevented from being come off from the coil 1 by inserting the I-shaped core 3 into the coil 1 after attaching the separate covers 2 and storing them in the U-shaped core 4.

In addition, the outer surfaces of the first walls 2a of the separate covers 2 are respectively provided with the projections 6, and the projections 6 each are formed to be inserted between the portions adjacent to each other of the electric wire of the coil 1 when the separate covers 2 are sequentially inserted into the coil 1 and moved toward the respective inner peripheral surfaces 1a on the short sides. This makes it possible to ensure the insulation between the portions adjacent to each other of the electric wire of the coil 1 by attaching the separate covers 2 particularly even in a case where a bare electric wire provided with no insulation coating is used for the coil 1.

Accordingly, in this inductor 8, the insulation between the inner peripheral surface 1a of the coil 1 and the I-shaped core 3 can be ensured by the first and second walls 2a and 2b of the separate covers 2, the insulation between each end surface 1b of the coil 1 and the outer leg 4a of the U-shaped core 4 can be ensured by the flange 2c, and the insulation between the portions adjacent to each other of the electric wire of the coil 1 can be ensured by the projection 6.

In addition, a clearance that is needed for the insulation between the outer peripheral surface of the coil 1 and the U-shaped core 4 can be formed by the flange 2c. As a result, according to the abovementioned inductor 8, it is possible to ensure the insulation that is needed between the coil 1 and the cores 3 and 4 with the inexpensive and simple structure.

### Second Embodiment

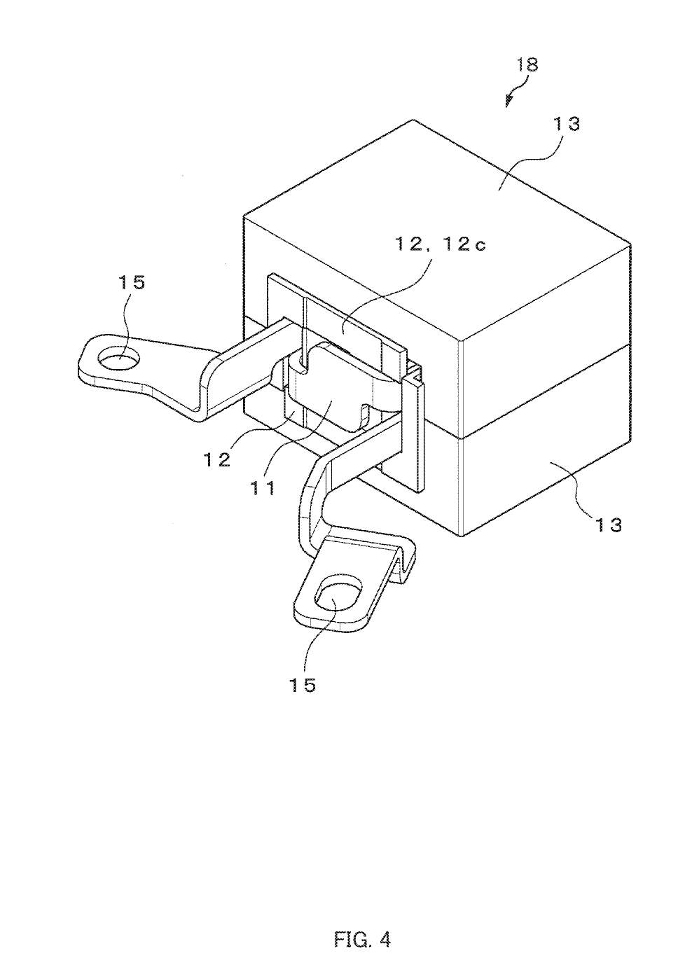

FIGS. 4, 5, and 6A to 6E illustrate an inductor 18 according to Second Embodiment of the present disclosure.

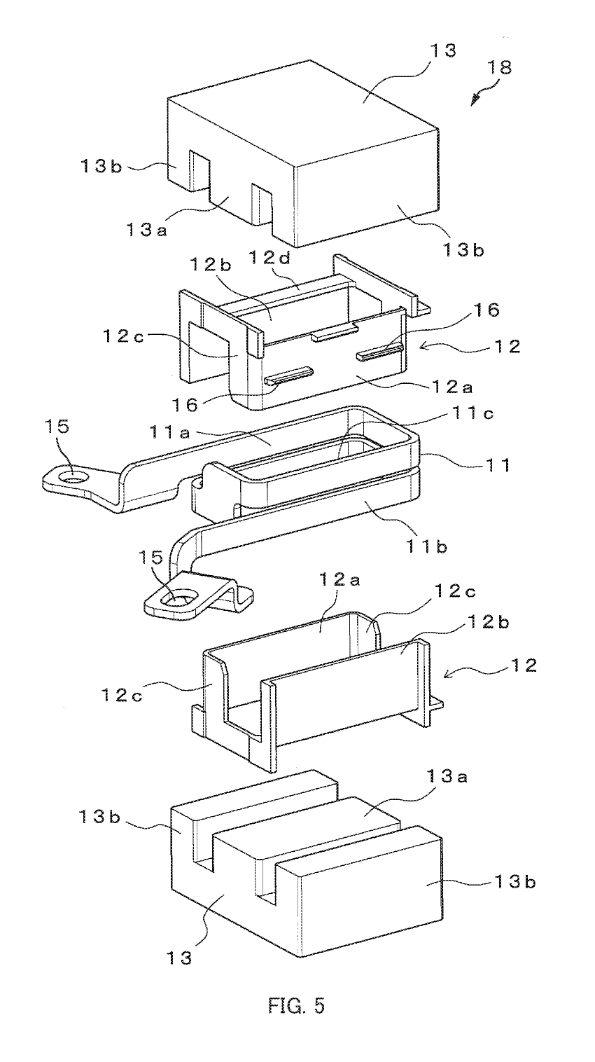

As illustrated in FIGS. 4 and 5, this inductor 18 schematically includes a coil 11 in which a rectangular copper wire is wound, a pair of separate covers (first and second separate covers) 12 made of insulating resin and having the same shape, which cover an inner peripheral surface 11a, an outer peripheral surface 11b, and two end surfaces 11c in the axial direction of the coil 11, and a pair of E-shaped cores 13 having conductivity that forms a closed magnetic circuit of such a shape that two hollow squares are arranged side by side by surrounding the center portion and the outer peripheries of the separate covers 12 and the coil 11.

In this case, the abovementioned coil 11 is also formed to have an appearance in a substantially rectangular tube shape, in which the pressed rectangular copper wire is bent in out-of-plane directions and its winding portions are adjacent to each other in the axial direction, and its terminal portions are respectively provided with screw holes 15 for screw fastening that are drilled during the abovementioned pressing. In this way, the coil 11 is formed by being wound while exposing a belt-shaped metal plate.

The separate covers 12 each includes a first wall 12a covering the entirety of one of the opposing inner peripheral surfaces 11a on the long sides of the rectangular tube shaped coil 11, a second wall (outer peripheral cover portion) 12b arranged parallel with the first wall 12a and covering the entirety of a surface of the outer peripheral surface 11b on the other long side of the coil 11, third walls 12c integrally formed between the first and second walls 12a and 12b and interposed between the inner peripheral surfaces 11a on the short sides of the coil 11 and end surfaces of a middle leg 13a of each E-shaped core 13, and a flange 12d formed on an end of the second wall 12b and covering one of the end surfaces (ends) 11c of the coil 11.

The first separate cover 12 and the second separate cover 12 are attached into the coil 11 from one end and the other end of the coil 11, respectively, such that the first and second separate covers 12 face each other.

To be more specific, the first wall 12a and the third wall 12c of the first separate cover 12 are inserted into the coil 11 along the one side of the inner peripheral surface 11a of the coil 11 from one end of the coil 11. The second wall 12b of the first separate cover 12 is along the outer peripheral surface on the side opposite to the inner peripheral surface 11a on the other side of the coil 11. The flange 12d of the first separate cover 12 then abuts on the one end surface 11c of the coil 11.

The first wall 12a and the third wall 12c of the second separate cover 12 are inserted into the coil 11 along the other side of the inner peripheral surface 11a of the coil 11 from the other end of the coil 11. The second wall 12b of the second separate cover 12 is along the outer peripheral surface on the side opposite to the inner peripheral surface 11a on the one side of the coil 11. The flange 12d of the second separate cover 12 then abuts on the other end surface 11c of the coil 11.

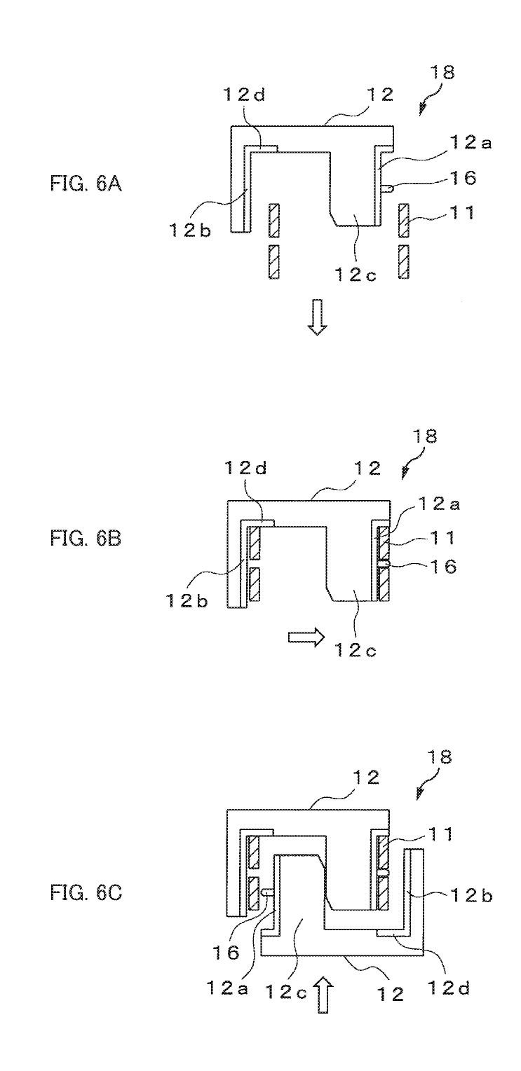

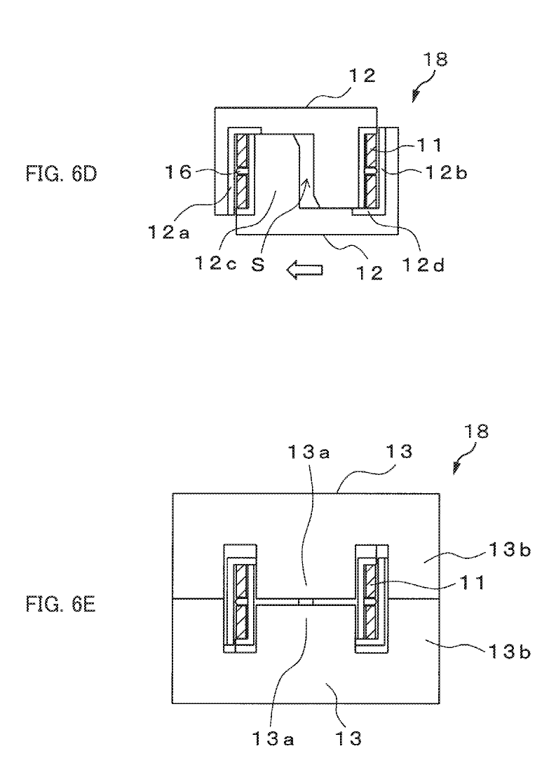

At this time, the first separate cover 12 and the second separate cover 12 are formed with such dimensions that the clearance S is formed between the third walls 12c of the first and second separate covers 12 in the circumferential direction of the coil 11 (see FIG. 6D).

Projections 16, which are to be inserted between the winding portions adjacent to each other in the axial direction of the coil 11, are integrally formed on a center portion of an outer surface of the first wall 12a of each separate cover 12. Each of the first walls 12a of the first separate cover 12 and the second separate cover 12 is provided with the projections 16, and the projections 16 are formed to be inserted between the portions adjacent to each other of the metal plate of the coil 11 such that these portions of the metal plate are kept separate from each other.

In order to assemble the inductor 18 having the abovementioned configuration, firstly one of the separate covers 12 is inserted from the one end surface 11c side of the coil 11 as illustrated in FIG. 6A, and thereafter the one separate cover 12 is moved toward the inner peripheral surface 11a on the one long side of the coil 11, so that the first wall 12a abuts on the abovementioned inner peripheral surface 1a while inserting the projections 16 between the winding portions adjacent to each other of the coil 11, and the second wall 12b abuts on the outer peripheral surface 11b on the long side that is opposed to the second wall 12b while covering the abovementioned one end surface 11c of the coil 11 with the flange 12d, as illustrated in FIG. 6B.

Subsequently, the other one of the separate covers 12 is inserted from the other end surface 11c side of the coil 11 as illustrated in FIG. 6C, and the other separate cover 12 is moved toward the inner peripheral surface 11a on the other long side of the coil 11, so that the first wall 12a abuts on the abovementioned inner peripheral surface 11a while inserting the projections 16 between the winding portions adjacent to each other of the coil 11, and the second wall 12b abuts on the outer peripheral surface 11b on the long side of the coil 11 that is opposed to the second wall 12b while covering the abovementioned other end surface 11c of the coil 11 with the flange 12d, as illustrated in FIG. 6D.

As a result, the third walls 12c of the separate covers 12 are arranged on the inner peripheral surface 11a on the short sides of the coil 11 while the clearance S is formed between the third walls 12c of the two separate covers 12 in the circumferential direction of the coil 11. Subsequently, as illustrated in FIG. 6E, the middle leg 13a of a first E-shaped core 13 of the pair of the E-shaped cores 13 is inserted into the center portion surrounded by the first walls 12a and the third walls 12c of the separate covers 12 on the inner peripheral surface 11a of the coil 11 from the one end surface 11c side of the coil 11, while outer legs 13b are arranged on the corresponding outer peripheral sides of the second walls 12b of the separate covers 12 covering the outer peripheral surface 11b of the coil 11. Likewise, the middle leg 13a of a second E-shaped core 13 is inserted into the center portion surrounded by the first walls 12a and the third walls 12c of the separate covers 12 on the inner peripheral surface 11a of the coil 11 from the other end surface 11c side of the coil 11, while outer legs 13b are arranged on the corresponding outer peripheral sides of the second walls 12b of the separate covers 12 covering the outer peripheral surface 11b of the coil 11. Accordingly, the assembly of the inductor 18 is completed.

According to the inductor 18 having the abovementioned configuration, it is possible to acquire operations and effects similar to those indicated in First Embodiment, and additionally, since the second wall 12b to be interposed between the outer peripheral surface 11b of the coil 11 and the outer legs 13b of the E-shaped cores 13 is integrally formed on each separate cover 12, it is possible to reliably ensure the insulation between the outer peripheral surface 11b of the coil 11 and the outer legs 13b of the E-shaped cores 13 even if they are close.

Both the abovementioned First and Second Embodiments describe only a case of using one formed by bending a bare electric wire with no insulation coating as the coil 1, 11 and thus the outer surface of the first wall 2a, 12a of each of the separate covers 2, 12 is provided with the projection(s) 6, 16 formed to be inserted between the winding portions adjacent to each other in the axial direction of the coil 1, 11 to ensure insulation; however, the present disclosure is not limited thereto. It is possible to omit the abovementioned projection(s) 6, 16 if an electric wire provided with insulation coating is used as the coil 1, 11, for example.

The abovementioned embodiments indicate a case of using the pair of the separate covers 2, 12 having the same shape; however, it is not limited thereto. It is possible to use a first separate cover and a second separate cover having different shapes. Third Embodiment

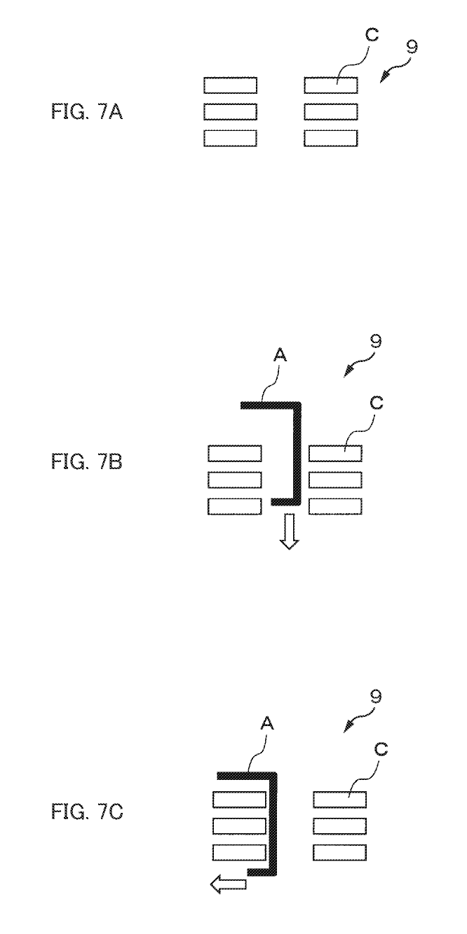

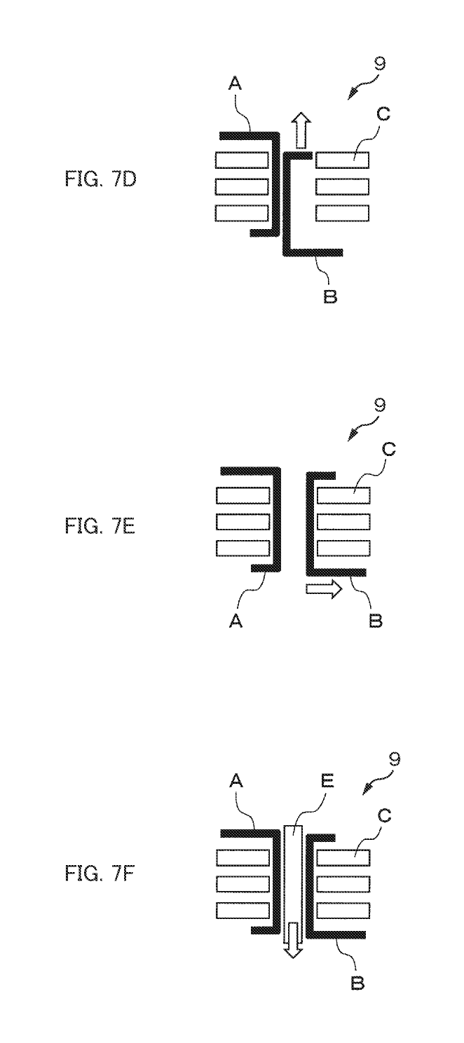

Next, an inductor 9 according to Third Embodiment is described with reference to FIGS. 7A to 7F. The inductor 9 includes a first separate cover A, a second separate cover B, a coil C, and a core E.

To be specific, the inductor 9 includes: the coil C in which an electric wire that is rectangular or oval in cross-section is wound with multiple turns; the core E which forms a closed magnetic circuit by being inserted into the center portion of the coil C and surrounding the outer periphery of the coil C; and covers which are made of insulating resin and are interposed at least between the abovementioned core E, and an inner peripheral surface and two end surfaces of the abovementioned coil C. The abovementioned covers include the first separate cover A, which covers a portion in the circumferential direction of the abovementioned inner peripheral surface and two end surfaces of the abovementioned coil C, and the second separate cover B, which covers another portion in the circumferential direction of the abovementioned inner peripheral surface and two ends of the abovementioned coil C, with the clearance S in the abovementioned circumferential direction formed with the first separate cover A.

As described above, the inductor 9 is configured such that the clearance S is formed between the first separate cover A and the second separate cover B in the circumferential direction of the coil C.

Thus, after the first separate cover A is inserted into the coil C as illustrated in FIGS. 7A and 7B, the first separate cover A can be moved toward the inner peripheral surface of the coil C as in FIG. 7C to cover a portion of the inner peripheral surface and a portion of the two end surfaces of the coil C, and subsequently, after the second separate cover B is inserted into the coil C as illustrated in FIG. 7D, the second separate cover B can be moved toward the inner peripheral surface of the coil C as in FIG. 7E to cover another portion of the inner peripheral surface and another portion of the two end surfaces of the coil C.

Then, as illustrated in FIG. 7F, insertion of the core E between the first and second separate covers A and B makes it possible to prevent the first and second separate covers A and B from being come off from the coil C.

Accordingly, it is possible to ensure the insulation between the coil C and the core E with the inexpensive and simple structure.

### Fourth Embodiment

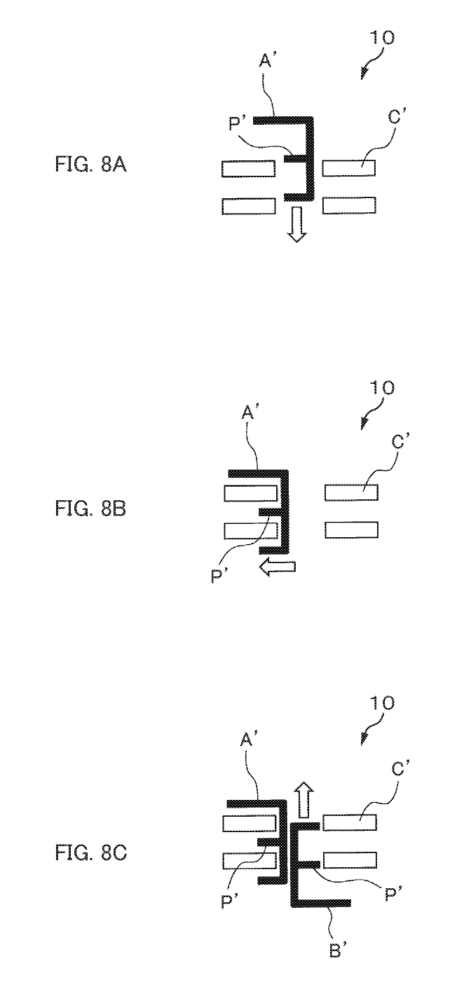

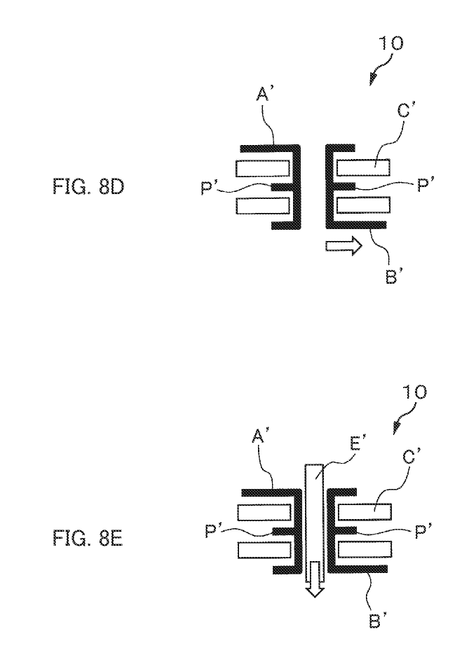

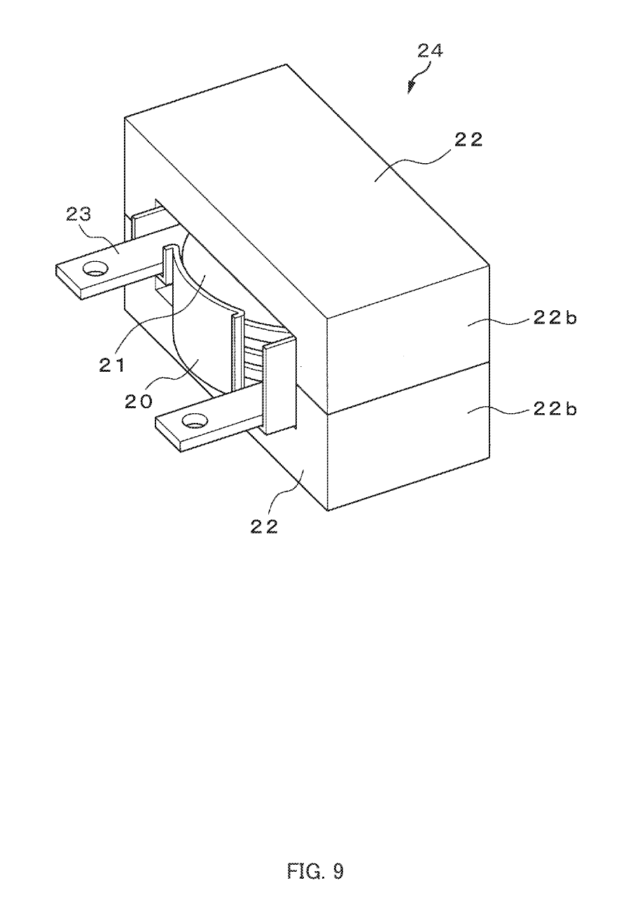

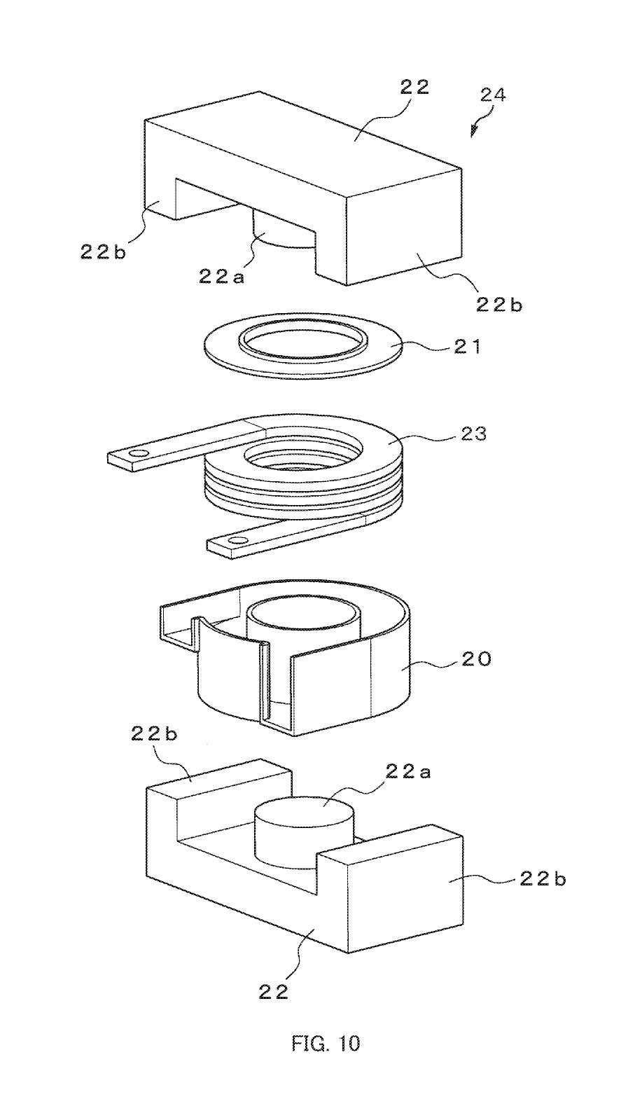

Next, an inductor 10 according to Fourth Embodiment is described with reference to FIGS. 8A to 8E. The inductor 10 includes a first separate cover A′ , a second separate cover B′, a coil C′, and a core E′.

To be specific, the electric wire constituting the coil C of the inductor 9 that is provided with no insulation coating is used for the coil C′ of the inductor 10, and a projection P′ to be inserted between the portions adjacent to each other of the abovementioned electric wire of the abovementioned coil C′ is formed on an outer surface of each of the abovementioned first and second separate covers A′ and B′.

As mentioned above, the bare electric wire provided with no insulation coating is used for the abovementioned coil C′ of the inductor 10.

In this case, as illustrated in FIGS. 8A to 8E, the outer surface of each of the abovementioned first and second separate covers A′ and B′ is provided with the projection P′ that is formed to be inserted between the portions adjacent to each other of the electric wire of the coil C′ while the first and second separate covers A′ and B′ are sequentially inserted into the coil C′ and moved toward the inner peripheral surface. This makes it possible to ensure the insulation between the portions adjacent to each other of the electric wire of the coil C′ concurrently with assembling of the first and second separate covers A′ and B′.

Also, it is possible to perform a bending process for positioning of a terminal portion and fastening position, while performing a pressing process on a steel plate to form the bare electric wire.

### Other Embodiments

In addition, it is possible to use covers having the same shape as the first and second separate covers in the abovementioned embodiments. According to such an aspect, it is possible to prepare the abovementioned first and second separate covers from a single mold, and the manufacturing cost can be decreased accordingly and management of parts in manufacturing can be facilitated.

Moreover, it is also possible to integrally form the outer peripheral cover portion, which is to be interposed between the outer peripheral surface of the coil and the core, on each of the first and second separate covers. According to such an aspect, it is possible to easily interpose an insulation material between the coil and the core surrounding the outer periphery of the coil when necessary.

The abovementioned embodiments are for easy understanding of the present disclosure and not for limiting and interpreting the present disclosure. The present disclosure maybe modified and improved without departing from the gist, and the present disclosure includes the equivalent thereof.

What is claimed is:

1. An inductor, comprising:
a coil;
a first separate cover made of insulating resin, the first separate cover including
a wall inserted into the coil from one end of the coil along one side of an inner peripheral surface of the coil, and
a flange continued from the wall and abutting on the one end;
a second separate cover made of insulating resin, the second separate cover including
a wall inserted into the coil from another end of the coil along another side of the inner peripheral surface of the coil, and
a flange continued from the wall and abutting on the other end; and
a conductive core to be stored between the wall of the first separate cover and the wall of the second separate cover in the coil.

2. The inductor according to claim 1, wherein
the coil is formed by winding a belt-shaped metal plate and
each of the wall of the first separate cover and the wall of the second separate cover is provided with a projection, the projection being formed to be inserted between portions adjacent to each other of the metal plate of the coil, so as to separate the portions adjacent to each other of the metal plate from each other.

3. The inductor according to claim 1, wherein
the first separate cover and the second separate cover have a same shape.

4. The inductor according to claim 2, wherein
the first separate cover and the second separate cover have a same shape.

5. The inductor according claim 1, wherein
the first separate cover further includes an outer peripheral cover portion along an outer peripheral surface of the coil on a side opposite to the inner peripheral surface on the other side,
the second separate cover further includes an outer peripheral cover portion along the outer peripheral surface of the coil on a side opposite to the inner peripheral surface on the one side, and
the core includes
a first E-shaped core including a middle leg to be inserted into the coil from the one end, and
a second E-shaped core including a middle leg to be inserted into the coil from the other end.

6. The inductor according claim 2, wherein
the first separate cover further includes an outer peripheral cover portion along an outer peripheral surface of the coil on a side opposite to the inner peripheral surface on the other side,
the second separate cover further includes an outer peripheral cover portion along the outer peripheral surface of the coil on a side opposite to the inner peripheral surface on the one side, and
the core includes
a first E-shaped core including a middle leg to be inserted into the coil from the one end, and
a second E-shaped core including a middle leg to be inserted into the coil from the other end.

7. The inductor according claim 3, wherein
the first separate cover further includes an outer peripheral cover portion along an outer peripheral surface of the coil on a side opposite to the inner peripheral surface on the other side,
the second separate cover further includes an outer peripheral cover portion along the outer peripheral surface of the coil on a side opposite to the inner peripheral surface on the one side, and
the core includes
a first E-shaped core including a middle leg to be inserted into the coil from the one end, and
a second E-shaped core including a middle leg to be inserted into the coil from the other end.

8. The inductor according claim 4, wherein
the first separate cover further includes an outer peripheral cover portion along an outer peripheral surface of the coil on a side opposite to the inner peripheral surface on the other side,
the second separate cover further includes an outer peripheral cover portion along the outer peripheral surface of the coil on a side opposite to the inner peripheral surface on the one side, and
the core includes
a first E-shaped core including a middle leg to be inserted into the coil from the one end, and
a second E-shaped core including a middle leg to be inserted into the coil from the other end.
